(19) United States
(12) Patent Application Publication
(10) Pub. No.: US 2022/0369595 A1
(43) Pub. Date: Nov. 24, 2022

(54) SOUND COLLECTING APPARATUS AND ANIMAL INFORMATION OUTPUT APPARATUS

(71) Applicant: Langualess inc., Tokyo (JP)

(72) Inventor: Joji YAMAGUCHI, Tokyo (JP)

(73) Assignee: Langualess inc., Tokyo (JP)

(21) Appl. No.: 17/824,903

(22) Filed: May 26, 2022

Related U.S. Application Data
(63) Continuation of application No. PCT/JP2020/044227, filed on Nov. 27, 2020.

(30) Foreign Application Priority Data
Nov. 29, 2019 (JP) 2019-216990

(51) Int. Cl. A01K 27/00; A01K 29/00

(52) U.S. Cl. CPC A01K 27/002; A01K 29/005

(57) ABSTRACT

A sound collecting apparatus according to an embodiment of the present disclosure includes a sound collecting part that detects sound in a body of an animal, a sound absorbing member that is provided on the sound collecting part, and a contact member that is provided on the sound absorbing member such that the contact member contacts a body surface of the animal, wherein the sound collecting part includes a housing, an opening causing the inside of the housing to be in communication with the outside of the housing on a surface of the housing proximate to the sound absorbing member, and a sound collecting element provided inside the housing for detecting the sound, wherein the sound absorbing member covers the opening of the housing, and protrudes toward the inside of the housing.

### CROSS-REFERENCE TO RELATED APPLICATIONS

The present application is a continuation application of International Application number PCT/JP2020/44227, filed on Nov. 27, 2020, which claims priority under 35 U.S.C §119(a) to Japanese Patent Application No. 2019-216990, filed on Nov. 29, 2019. The contents of these applications are incorporated herein by reference in their entirety.

### BACKGROUND OF THE INVENTION

The present disclosure relates to a sound collecting apparatus and an animal information output apparatus for detecting sound and outputting information about an animal.

In recent years, the number of households with pets such as dogs and cats has been increasing, and there is an increasing demand to know an emotion of an animal. Japanese Unexamined Patent Application Publication No. 2010-187631 discloses an apparatus that acquires a biopotential of an animal by having a foot of the animal placed on an electrode to apply a weak current to the body of the animal, thereby measuring a degree of relaxation and excitement of the animal on the basis of the biopotential.

However, the apparatus disclosed in Japanese Unexamined Patent Application Publication No. 2010-187631 requires the foot of the animal to be placed on the electrode, and it is difficult to say that the apparatus acquires information about the body of the animal in its natural state. Because it is impractical for the animal to live with the electrode secured to its feet, it is difficult for the apparatus disclosed in Japanese Unexamined Patent Application Publication No. 2010-187631 to acquire the information about the body of the animal in daily life and estimate the emotion of the animal.

### BRIEF SUMMARY OF THE INVENTION

The present disclosure focuses on this point, and an object thereof is to acquire information about a body of an animal in daily life.

A sound collecting apparatus according to a first aspect of the present disclosure includes a sound collecting part that detects sound in a body of an animal, a sound absorbing member that is provided on the sound collecting part, and a contact member that is provided on the sound absorbing member such that the contact member contacts a body surface of the animal, wherein the sound collecting part includes a housing provided with an opening causing the inside of the housing to be in communication with the outside of the housing on a surface of the housing proximate to the sound absorbing member, and a sound collecting element provided inside the housing for detecting the sound, wherein the sound absorbing member covers the opening of the housing, and protrudes toward the inside of the housing.

An animal information output apparatus according to a second aspect of the present disclosure includes a sound collecting apparatus, a notification device, and a mounting member that secures the sound collecting apparatus and the notification device to a body of an animal, wherein the notification device includes a notification part for notifying information about the animal identified on the basis of sound detected by the sound collecting apparatus, wherein the sound collecting apparatus includes a sound collecting part for detecting sound in the body of the animal, a sound absorbing member provided on the sound collecting part, and a contact member provided on the sound absorbing member such that the contact member contacts a body surface of an animal, wherein the sound collecting part includes a housing having an opening causing the inside of the housing to be in communication with the outside of the housing on a surface of the housing proximate to the sound absorbing member of the housing, and a sound collecting element provided inside the housing for detecting the sound, wherein the sound absorbing member covers the opening of the housing, and protrudes toward the inside of the housing.

A sound collecting apparatus according to a third aspect of the present disclosure includes a sound collecting part that detects sound in a body of an animal, a support member that includes an accommodation part for accommodating at least a portion of the sound collecting part, a sound absorbing member that is provided on the sound collecting part, a contact member that is provided on the sound absorbing member such that the contact member contacts a body surface of the animal, and a buffering member that is provided such that the buffering member contacts i) the support member and ii) a portion of the contact member that protrudes beyond the accommodation part, wherein the sound collecting part includes a housing having an opening causing the inside of the housing to be in communication with the outside of the housing on a surface of the housing proximate to the sound absorbing member of the housing, and a sound collecting element provided inside the housing for detecting the sound.

### BRIEF DESCRIPTION OF THE DRAWINGS

FIG. 1 is an external view of an animal information output apparatus mounted on an animal according to the embodiment.

FIG. 2 is an external view of the animal information output apparatus not mounted on the animal according to the embodiment.

FIG. 3 is a block diagram of the animal information output apparatus according to the embodiment.

FIG. 4 is a cross-sectional view of a sound collecting apparatus according to the embodiment.

FIG. 5 is an exploded perspective view of the sound collecting apparatus according to the embodiment.

FIG. 6A is a cross-sectional view of the sound collecting apparatus according to a variation.

FIG. 6B is a cross-sectional view of the sound collecting apparatus according to a variation.

FIG. 6C is a cross-sectional view of the sound collecting apparatus according to a variation.

FIG. 7 is a front view of a notification device displaying information about an animal.

FIG. 8 is a flowchart of an animal information output method executed by the animal information output apparatus according to the embodiment.

### DETAILED DESCRIPTION OF THE INVENTION

Hereinafter, the present invention will be described through exemplary embodiments of the present invention, but the following exemplary embodiments do not limit the invention according to the claims, and not all of the combinations of features described in the exemplary embodiments are necessarily essential to the solution means of the invention.

### Overview of Animal Information Output Apparatus

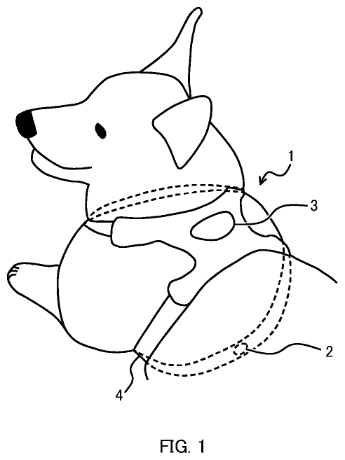

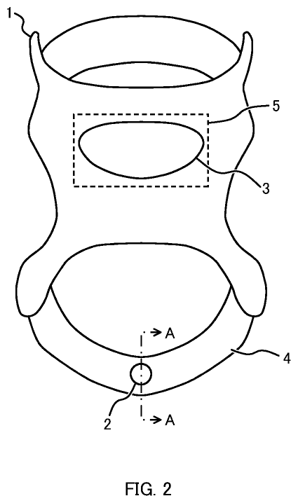

FIG. 1 is an external view of an animal information output apparatus 1 mounted on an animal according to the embodiment. FIG. 2 is an external view of the animal information output apparatus 1 not mounted on the animal according to the embodiment. In FIGS. 1 and 2, hidden portions of the animal information output apparatus 1 are represented by dashed lines. FIG. 1 shows a state in which the animal information output apparatus 1 is mounted on a dog. The animal information output apparatus 1 is not limited to being mounted only on dogs, and may be mounted on small animals such as cats, large animals such as elephants, sea animals such as dolphins, or other animals, for example.

The animal information output apparatus 1 includes a sound collecting apparatus 2, a notification device 3, a mounting member 4, and a controller 5. The sound collecting apparatus 2 is an apparatus for detecting sound in a body of an animal. The sound collecting apparatus 2 includes a sound collecting part that detects the sound in the body of the animal, a sound absorbing member that absorbs the sound such that the sound collecting part can mainly detect the sound in a frequency band to be detected (for example, heartbeat or breathing sound), and a contact member that contacts a body surface of the animal. The sound collecting apparatus 2 outputs information indicating the detected sound to the controller 5. The detailed structure of the sound collecting apparatus 2 will be described later.

The notification device 3 displays information in accordance with a signal outputted by the controller 5. The notification device 3 includes a display part (display), such as a lamp or a liquid crystal display, capable of displaying the information. The notification device 3 may include an audio output part, such as a speaker, capable of outputting the information by audio.

The mounting member 4 is a member for securing the sound collecting apparatus 2, the notification device 3, and the controller 5 to the body of the animal. The mounting member 4 is a belt made of rubber or resin, for example. The mounting member 4 may have a fastener such as a buckle. The mounting member 4 secures the notification device 3 to the back of the animal such that a user can see the notification device 3. The user may be an owner of the animal, a person who cares for the animal, a medical professional who treats the animal, or the like, for example.

The mounting member 4 is a member for securing the sound collecting apparatus 2 to a place where the sound to be detected can be detected. For example, the mounting member 4 secures the sound collecting apparatus 2 to the chest of the animal when the sound collecting apparatus 2 detects the heartbeat. For example, the mounting member 4 secures the sound collecting apparatus 2 to the neck or chest of the animal when the sound collecting apparatus 2 detects the breathing sound. The animal information output apparatus 1 may include a plurality of sound collecting apparatuses 2 corresponding to a plurality of sounds to be detected.

The controller 5 is a computer that identifies information about the animal on the basis of the sound detected by the sound collecting apparatus 2. The information about the animal is information indicating an emotion of the animal or a health status of the animal, for example. The controller 5 causes the notification device 3 to notify the identified information about the animal.

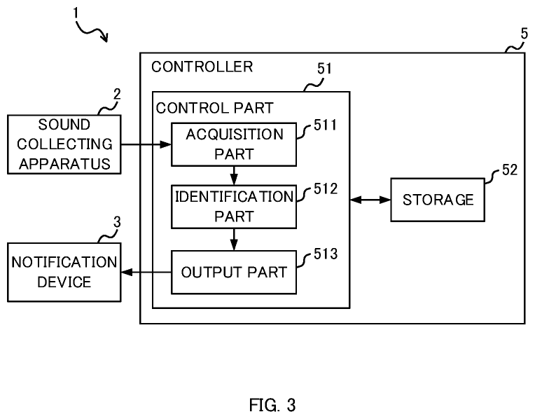

FIG. 3 is a block diagram of the animal information output apparatus 1 according to the embodiment. In FIG. 3, arrows indicate main data flows, and there may be data flows other than those shown in FIG. 3. In FIG. 3, each block is not a hardware (device) unit configuration but a functional unit configuration. Therefore, the blocks shown in FIG. 3 may be implemented in a single apparatus or may be implemented separately in a plurality of apparatuses. Data may be exchanged between blocks via any means, including a data bus, a network, a portable storage medium, or the like.

The controller 5 includes a control part 51 and a storage 52. The control part 51 includes an acquisition part 511, an identification part 512, and an output part 513. The storage 52 is a storage medium including a Read Only Memory (ROM), a Random Access Memory (RAM), a hard disk drive, and the like. The storage 52 stores a program executed by the control part 51 in advance. The storage 52 may be provided outside the animal information output apparatus 1, and in this case, the storage 52 may exchange the data with the control part 51 via a network.

The control part 51 is a processor such as a Central Processing Unit (CPU), and functions as the acquisition part 511, the identification part 512, and the output part 513 by executing the program stored in the storage 52. At least a part of the functions of the control part 51 may be executed by an electric circuit. Further, at least a part of the functions of the control part 51 may be implemented by the control part 51 executing a program executed via a network.

The animal information output apparatus 1 according to the present embodiment is not limited to the specific configuration shown in FIG. 3. The sound collecting apparatus 2, the notification device 3, and the controller 5 may be configured by connecting two or more physically separated apparatuses by wire or wirelessly. In the present embodiment, the controller 5 is integrated with the animal information output apparatus 1, but may be a computer provided outside the animal information output apparatus 1. In this case, the sound collecting apparatus 2, the notification device 3, and the controller 5 exchange information with each other through wireless communication.

### Structure of Sound Collecting Apparatus

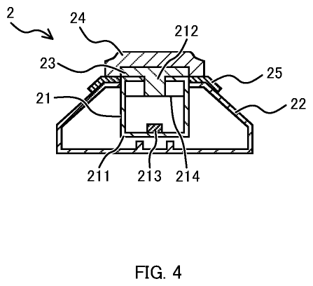

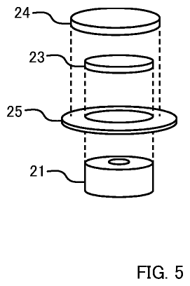

A structure of the sound collecting apparatus 2 according to the present embodiment will be described in detail below. FIG. 4 is a cross-sectional view of the sound collecting apparatus 2 according to the embodiment. FIG. 4 shows a cross-section of the sound collecting apparatus 2 at a line A-A in FIG. 2. FIG. 5 is an exploded perspective view of the sound collecting apparatus 2 according to the embodiment. FIG. 5 shows the sound collecting apparatus 2 disassembled along a vertical direction of FIG. 4 (a support member 22 is omitted). When the sound collecting apparatus 2 is secured to the body of the animal, the body of the animal is positioned on an upper side of FIGS. 4 and 5.

The sound collecting apparatus 2 includes a sound collecting part 21, the support member 22, a sound absorbing member 23, a contact member 24, and a buffering member 25. As shown in FIG. 5, the sound absorbing member 23 and the contact member 24 are overlaid on an upper surface of the sound collecting part 21, and the buffering member 25 is provided along the side surface of the sound collecting part 21.

The sound collecting part 21 is a member for detecting the sound in the body of the animal. The sound collecting part 21 includes a housing 211, an opening 212, a sound collecting element 213, and a diaphragm 214. The housing 211 is a hollow cylindrical member. There is a circular opening 212 provided for causing the inside of the housing 211 to be in communication with the outside of the housing 211 on an upper surface of the housing 211, which is on a surface facing the sound absorbing member 23 (surface proximate to the animal's body), for example.

The sound collecting element 213 and the diaphragm 214 (diaphragm) are fixed inside the housing 211. The sound collecting element 213 is provided on an inner wall of the housing 211 on the opposite side of the opening 212 with the diaphragm 214 interposed therebetween. The sound collecting element 213 detects the sound through the opening 212 by detecting vibration of the diaphragm 214 as a change in capacitance, for example. The sound collecting part 21 does not have to detect the sound only by using the specific method shown here, and may detect the sound using other methods.

The support member 22 supports the sound collecting part 21. The support member 22 includes an accommodation part that accommodates at least a portion of the sound collecting part 21. The accommodation part accommodates the portion of the sound collecting part 21 for a predetermined height from its bottom surface (a surface opposite to the sound absorbing member 23) toward its upper surface (the surface facing the sound absorbing member 23).

The sound absorbing member 23 is a frequency selecting member (also referred to as a frequency filter) that mainly allows the sound in a frequency band to be detected (for example, the heartbeat and breathing sound) to pass through, while mainly absorbing the sound outside of that frequency band. The sound absorbing member 23 is made of a gel which is a polymer elastic material having a three-dimensional network structure, for example. The sound absorbing member 23 covers the opening 212 of the housing 211 of the sound collecting part 21, and protrudes toward the inside of the housing 211 through the opening 212. Such a configuration allows the sound absorbing member 23 to restrict air outside the sound collecting part 21 from entering the housing 211 from the opening 212, thereby reducing the amount of air between the sound absorbing member 23 and the diaphragm 214. Therefore, the sound collecting apparatus 2 can further reduce noise, which is sound other than the sound inside the body of the animal, being transmitted through the air compared to the sound inside the body of the animal, such that the sound collecting apparatus 2 can stably acquire the information about the body of the animal in daily life.

Here, “the sound absorbing member 23 protrudes toward the inside of the housing 211” means that at least a portion of the sound absorbing member 23 is positioned closer to the inside of the housing 211 (a position closer to the sound collecting element 213) than the surface of the opening 212 (the upper end of the opening 212 in FIG. 4). For better noise reduction, the sound absorbing member 23 desirably blocks the entire opening 212. Further, the sound absorbing member 23 is desirably in contact with the diaphragm 214 inside the housing 211. This allows the sound absorbing member 23 to further reduce the amount of air between the sound absorbing member 23 and the diaphragm 214, thereby significantly reducing the noise that is not the sound inside the body of the animal.

The sound absorbing member 23 may include i) a first sound absorbing member that covers the opening 212 of the housing 211 of the sound collecting part 21, and ii) a second sound absorbing member that protrudes toward the inside of the housing 211 through the opening 212. The second sound absorbing member may be made of a material different from that of the first sound absorbing member. Such a configuration allows for more flexibility in setting the frequency band selected by the sound absorbing member 23 by forming the second sound absorbing member with a material harder than that of the first sound absorbing member (for example, a material with a greater elastic modulus than the material of the first sound absorbing member), for example.

The contact member 24 is a member provided on the sound absorbing member 23 such that the contact member 24 contacts the body surface of the animal. The contact member 24 is made of a sponge that is a porous elastic material, for example. The contact member 24 can reduce frictional noise generated with the body surface of the animal by making flexible contact with the body surface (mainly hair) of the animal, such that the sound collecting apparatus 2 can stably acquire the information about the body of the animal in daily life.

The sound absorbing member 23 is made of a material softer than that of the contact member 24. The elastic modulus of the sound absorbing member 23 is configured to be smaller than the elastic modulus of the contact member 24, for example. For example, low frequency sound such as a heartbeat or breathing sound has difficulty passing through a hard material, but easily passes through a soft material. By forming the sound absorbing member 23 covering the opening 212 with a relatively soft material as described above, the sound absorbing member 23 can mainly allow the sound inside the body of the animal to pass through. Further, a characteristic frequency of the sound absorbing member 23 may be configured to be smaller than a characteristic frequency of the contact member 24.

The buffering member 25 is provided such that the buffering member 25 contacts i) the support member 22 and ii) a portion of the contact member 24 that protrudes beyond the accommodation part provided to the support member 22 (for example, a portion of the contact member 24 that protrudes beyond the sound collecting part 21 accommodated in the accommodation part). The buffering member 25 is made of a material different from that of the contact member 24 (for example, a material softer than the material of the contact member 24), and is made of a sponge, for example. Such a configuration allows the buffering member 25 to suppress noise transmission from the support member 22 to the sound absorbing member 23 and the contact member 24.

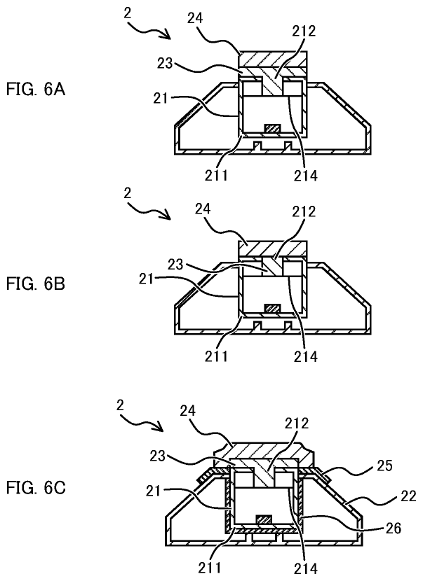

FIGS. 6A to 6C are cross-sectional views of the sound collecting apparatus 2 according to a variation of the present embodiment. FIGS. 6A to 6C respectively show the cross-section of the sound collecting apparatus 2 at the line A-A in FIG. 2. FIG. 6A shows the sound collecting apparatus 2 with a configuration that omits the buffering member 25 compared to the configuration in FIG. 4. FIG. 6B shows the sound collecting apparatus 2 with a configuration that omits the buffering member 25 and that has the sound absorbing member 23 fitting within the opening 212 of the housing 211, compared to the configuration in FIG. 4.

In the configurations of FIGS. 6A and 6B, the contact member 24 maintains contact with the body surface of the animal and the sound absorbing member 23 selectively passes the sound inside the body of the animal, such that the sound collecting apparatus 2 can stably acquire the information about the body of the animal in daily life.

As compared with the configuration of FIG. 4, FIG. 6C further includes a protective member 26 that covers the side surface and the bottom surface of the housing 211. The protective member 26 is made of a gel or sponge, for example. In the configuration in FIG. 6C, the protective member 26 can reduce the sound transmitted from the side surface and the bottom surface of the housing 211 to the sound collecting part 21, such that the sound collecting apparatus 2 can detect the sound with further reduced noise.

In each configuration shown in FIGS. 6A to 6C, the sound absorbing member 23 does not have to be in contact with the diaphragm 214. Further, in each of the configurations shown in FIGS. 6A to 6C, the sound absorbing member 23 may cover the opening 212 instead of protruding toward the inside of the housing 211. In such a configuration as well, the sound collecting apparatus 2 can reduce the noise, which is sound other than the sound inside the body.

### Processing Performed by Animal Information Output Apparatus

The processing performed by the animal information output apparatus 1 according to the present embodiment will be described in detail below. After the animal information output apparatus 1 is mounted on the body of the animal, the sound collecting apparatus 2 starts detecting the sound using the sound collecting part 21. The sound collecting apparatus 2 outputs sound information indicating the sound detected by the sound collecting part 21 to the controller 5.

In the controller 5, the acquisition part 511 acquires the sound information outputted from the sound collecting apparatus 2. The identification part 512 identifies the information about the animal on the basis of the sound information acquired by the acquisition part 511. The information about the animal is information indicating the emotion of the animal or information indicating the health status of the animal that can be identified on the basis of the sound information.

For example, the identification part 512 acquires heartbeat information indicating the heartbeat of the animal by performing predetermined signal processing (for example, a noise filter and a low-pass filter) on the sound indicated by the sound information acquired by the acquisition part 511. The identification part 512 estimates the emotion of the animal by analyzing heartbeat fluctuation in the heartbeat indicated by the acquired heartbeat information. The emotion of the animal includes whether or not the animal is stressed, sleepy, or interested in something, for example. The identification part 512 identifies the information indicating the estimated emotion of the animal as the information about the animal.

Further, the identification part 512 may also acquire a heart rate and breathing frequency of the animal, and the number of times that the animal scratches itself as the information indicating the health status of the animal by performing predetermined signal processing (for example, noise filter and low-pass filter) on the sound indicated by the sound information acquired by the acquisition part 511. The identification part 512 identifies the acquired information indicating the health status of the animal as the information about the animal.

The identification part 512 identifies information not limited to the specific information shown here, and may identify information about other animals that can be identified from the sound inside the body of the animal.

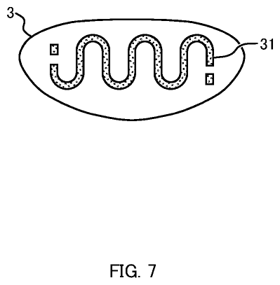

The output part 513 outputs the information about the animal identified by the identification part 512, to the notification device 3. The notification device 3 displays the information about the animal outputted by the controller 5. FIG. 7 is a front view of the notification device 3 displaying the information about the animal. The notification device 3 includes a lamp 31 such as a Light Emitting Diode (LED), for example.

In the notification device 3, the lamp 31 displays the information about the animal by emitting light in a different manner (for example, color of light emission, intensity of light emission, timing of light emission, or the like) depending on the information about the animal. This allows the user to easily grasp the information indicating the emotion of the animal and the health status of the animal, which are identified on the basis of the sound inside the body of the animal.

The manner in which the lamp 31 emits light may be designated by the controller 5 on the basis of the information about the animal, or may be determined by the notification device 3 on the basis of the information about the animal. The notification device 3 may display the information about the animal on a liquid crystal display instead of or in addition to the lamp 31. The notification device 3 may output audio indicating the information about the animal instead of or in addition to the display of the information.

### Flowchart of Animal Information Output Method

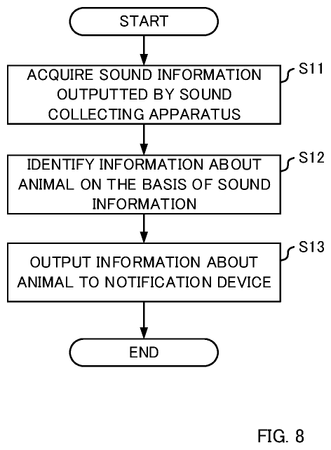

FIG. 8 is a flowchart of an animal information output method executed by the animal information output apparatus 1 according to the embodiment. After the animal information output apparatus 1 is mounted on the body of the animal, the sound collecting apparatus 2 starts detecting the sound using the sound collecting part 21. The sound collecting apparatus 2 outputs the sound information indicating the sound detected by the sound collecting part 21 to the controller 5. In the controller 5, the acquisition part 511 acquires the sound information outputted by the sound collecting apparatus 2 (step S11).

The identification part 512 identifies the information about the animal on the basis of the sound information acquired by the acquisition part 511 (step S12). The output part 513 outputs the information about the animal identified by the identification part 512 to the notification device 3 (step S13). The notification device 3 notifies the information about the animal outputted by the controller 5.

### Effects of the Embodiment

In the animal information output apparatus 1 according to the present embodiment, the sound collecting apparatus 2 includes i) the sound absorbing member 23 that covers the opening 212 of the housing 211 of the sound collecting part 21 and protrudes toward the inside of the housing 211 through the opening 212, and ii) the contact member 24 that is provided on the sound absorbing member 23 such that the contact member contacts the body surface of the animal. With such a configuration, the contact member 24 keeps contact with the body surface of the animal, and the sound absorbing member 23 selectively transmits the sound inside the body of the animal, whereby the sound collecting apparatus 2 can stably acquire the information about the body of the animal in daily life.

The present invention has been described above on the basis of the exemplary embodiments. The technical scope of the present invention is not limited to the scope explained in the above embodiments, and it is obvious to those skilled in the art that various changes and modifications within the scope of the invention may be made. An aspect to which such changes and modifications are added can be included in the technical scope of the present invention is obvious from the description of the claims.

A processor of the controller 5 executes each step (process) included in the animal information output method shown in FIG. 8. The processor of the controller 5 executes the animal information output method shown in FIG. 8 by reading a program for executing the animal information output method shown in FIG. 8 from the storage and controlling each unit of the animal information output apparatus 1 by executing the program. Some of the steps included in the animal information output method shown in FIG. 8 may be omitted, the order of the steps may be changed, and a plurality of steps may be performed in parallel.

What is claimed is:

1. A sound collecting apparatus comprising:
a sound collecting part that detects sound in a body of an animal;
a sound absorbing member that is provided on the sound collecting part; and
a contact member that is provided on the sound absorbing member such that the contact member contacts a body surface of the animal, wherein
the sound collecting part includes:
a housing provided with an opening causing the inside of the housing to be in communication with the outside of the housing on a surface of the housing proximate to the sound absorbing member, and
a sound collecting element provided inside the housing for detecting the sound, wherein
the sound absorbing member covers the opening of the housing, and protrudes toward the inside of the housing.

2. The sound collecting apparatus according to claim 1, wherein
the contact member is made of a sponge, and
the sound absorbing member is made of a gel.

3. The sound collecting apparatus according to claim 1, wherein
the sound absorbing member is made of a material softer than the material of the contact member.

4. The sound collecting apparatus according to claim 1, wherein
the sound absorbing member includes i) a first sound absorbing member that covers the opening of the housing and ii) a second sound absorbing member that protrudes toward the inside of the housing through the opening, and
the second sound absorbing member is made of a material different from the material of the first sound absorbing member.

5. The sound collecting apparatus according to claim 1, wherein
the sound collecting part includes a diaphragm provided between the sound collecting element inside the housing and the opening, and
the sound absorbing member is in contact with the diaphragm.

6. The sound collecting apparatus according to claim 1, further comprising:
a support member that supports the sound collecting member; and
a buffering member that is provided such that the buffering member contacts i) the support member and ii) a portion of the contact member that protrudes beyond the sound collecting part.

7. The sound collecting apparatus according to claim 6, wherein
the buffering member is made of a sponge.

8. An animal information output apparatus comprising:
a sound collecting apparatus;
a notification device; and
a mounting member that secures the sound collecting apparatus and the notification device to a body of an animal, wherein
the notification device includes a notification part for notifying information about the animal identified on the basis of sound detected by the sound collecting apparatus, wherein
the sound collecting apparatus includes:
a sound collecting part for detecting sound in the body of the animal,
a sound absorbing member provided on the sound collecting part, and
a contact member provided on the sound absorbing member such that the contact member contacts a body surface of an animal, wherein
the sound collecting part includes:
a housing having an opening causing the inside of the housing to be in communication with the outside of the housing on a surface of the housing proximate to the sound absorbing member of the housing, and
a sound collecting element provided inside the housing for detecting the sound, wherein
the sound absorbing member covers the opening of the housing, and protrudes toward the inside of the housing.

9. The animal information output apparatus according to claim 8, wherein
the sound absorbing member selectively passes sound emitted from a portion of the body of the animal to which the sound collecting part is secured by the mounting member.

10. A sound collecting apparatus comprising:
a sound collecting part that detects sound in a body of an animal;
a support member that includes an accommodation part for accommodating at least a portion of the sound collecting part;
a sound absorbing member that is provided on the sound collecting part;
a contact member that is provided on the sound absorbing member such that the contact member contacts a body surface of the animal; and
a buffering member that is provided such that the buffering member contacts i) the support member and ii) a portion of the contact member that protrudes beyond the accommodation part, wherein
the sound collecting part includes:
a housing having an opening causing the inside of the housing to be in communication with the outside of the housing on a surface of the housing proximate to the sound absorbing member of the housing, and
a sound collecting element provided inside the housing for detecting the sound.
